(19) United States
(12) Patent Application Publication
(10) Pub. No.: US 2006/0073255 A1
(43) Pub. Date: Apr. 6, 2006

(54) Non-hygroscopic, low-or no-calorie sugar substitute

(76) Inventors: Steve Catani, Athens, GA (US); Shyhyuan Liao, West Windsor, NJ (US); Steve Clarke, North Brunswick, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/958,090

(22) Filed: Oct. 4, 2004

(51) Int. Cl. A23L 1/236

(52) U.S. Cl. 426/548

(57) ABSTRACT

The present invention provides a sweetener composition, preferably containing at least one chlorodeoxysugar derivative, such as sucralose. This sweetener composition can be incorporated as a direct substitute for sucrose sugar to produce a wide variety of medicinal products and food products having reduced calorie content.

### FIELD OF THE INVENTION

The invention relates to a sweetener composition, its use in food products and methods for preparing sucralose-containing concentrated or bulked sweetener compositions.

### BACKGROUND OF THE INVENTION

Intense sweetening agents are natural or synthetic compounds, which have a sweetening intensity greater than that of sugar (sucrose) and which oftentimes have a lower caloric value than that of sugar. Because the intense sweeteners provide greater sweetening capacity than sugar, smaller amounts of the sweeteners will provide sweetening intensity equivalent to larger amounts of sugar. Intense sweeteners are well known in the art and are widely used in place of sugar in many low calorie and/or noncariogenic compositions. Intense sweeteners can provide compositions that have decreased caloric value, as compared to sugar-sweetened compositions, because far lower amounts of the intense sweetener are required to achieve optimum sweetness in the composition.

Intense sweeteners have a wide range of chemically distinct structures and hence possess varying properties. These intense sweetener compounds include water-soluble artificial sweeteners such as 1,2-benzisothiazol-3(2H)-one 1,1-dioxide (saccharin and its salts), cyclohexylsulfamic acid (cyclamate and its salts), and the potassium salt of 6-methyl-1,2,3-oxathiazin-4(3H)-one-2,2-dioxide (Acesulfame-K, a commercially available product from Hoechst Celanese Corporation, Somerville, N.J.), proteins such as thaumatin (Talin, a commercially available product of Tate & Lyle Products, Reading, United Kingdom), chlorodeoxysugar derivatives (such as Sucralose, a commercially available product of Tate & Lyle), and dipeptides such as N-L-alpha-aspartyl-L-phenylalanine I-methyl ester (Aspartame, a commercially available product of the Nutrasweet Company, Deerfield, Ill.) and L-alpha-aspartyl-D-alanine N-(2,2,4,4-tetramethyl-3-thietanyl)amide (Alitame, a commercially available product of Pfizer, New York, N.Y.), and dihydrochalcones.

Sucralose (4,1′,6′-trichloro-4,1′,6′-trideoxygalacto-sucrose) is a high intensity sweetener made from sucrose that can be used in many food and beverage applications. One method for using intense sweeteners is as a direct substitute for sucrose sugar in tabletop and cooking applications. In order for intense sweeteners to have the same look, feel and consistency, the intense sweetener must be blended or admixed with bulking agents or similar carrier systems into so-called bulked sweetener compositions. Various blends of intense sweeteners, sucrose and/or other sweetening agents have been explored for this application. A bulked sweetener composition is described as having the same sweetness as an equivalent volume of sucrose and prepared by spray drying a mixture that consisted of a maltodextrin solution (222.2 grams dry weight) and 4,1′-dichloro-4,1′-dideoxygalactosucrose (1.7 grams) or 1,1′,6′-trichloro-4,1′6′6-trideoxygalactosesucrose (0.5 grams). Published PCT patent application WO 89/03182 discloses synergistic sweetening compositions that comprise sucralose and a saccharide bulk-sweetening agent selected from the group consisting of fructose, glucose, maltose, xylitol, mannitol, and sorbitol.

Numerous attempts have been made to optimize the sweetening effects of blended products, though not necessarily for use as bulked sweeteners. Sucralose has been dry blended with other sweeteners such as acesulfame-K (6-methyl-1,2,3,-oxathiazin-4(3H)-one-2,2-dioxide, potassium salt) as described in U.S. Pat. No. 4,495,170. U.S. Pat. No. 4,959,225 discloses synergistic sweetening compositions that comprise sucralose and maltitol. U.S. Pat. No. 4,820,528 discloses a codried composition consisting essentially of about 99.9% to 90% saccharin and about 0.1% to about 10% of a halodeoxysugar, by weight. European Patent Application 267,809 discloses synergistic sweetening compositions that comprise sucralose and maltodextrin. U.S. Pat. No. 5,380,541 describes blends of sucralose and a sweet saccharide selected from the group consisting of fructose, glucose, maltose, other glucooligosaccharides, fructose mixed with glucose and/or glucooligosaccharides, lactose, isomaltose, and sugar alcohols. Synergies are allegedly achieved at ratios of relative sweetness contributions provided by sucralose and the sweet saccharide of between 5:1 to 1:5.

The resulting sweetener compositions are frequently intended for use in the food, beverage and medicinal products. U.S. Pat. No. 4,872,884 discloses reduced calorie chewing gums wherein soft polyvinyl acetate containing gum bases having an enhanced hydrophilic nature are employed in amounts of greater than about 50% in combination with up to about 0.60% of an intense sweetening agent and up to about 40% of a bulk sweetening agent. Published PCT patent application WO 89/08672 discloses a chewing gum composition having controlled sweetness wherein the gum contains an effective amount of sucralose. U.S. Pat. No. 6,294,999 proposes a sugar formulation for chewing gum in which sucralose and other intense sweeteners are substituted (alone or as a mixture) on a one-to-one basis for a co-crystallized erythritol. See examples 107-117.

In many ingestible compositions, the use of an intense sweetener also requires the concurrent use of a bulking agent to provide acceptable bulk and texture to the final product. Many and various bulking agents (carriers, diluents, extenders) are known. The particular bulking agent chosen for a specific composition must be sufficient in physical make-up to provide the specific bulk and texture required. Suitable carbohydrate bulking agents include sugars, sugar alcohols and mixtures thereof. Other suitable bulking agents include minerals such as calcium carbonate, talc, dicalcium phosphate, and the like.

Suitable sugar bulking agents include monosaccharides, disaccharides and polysaccharides such as, glucose (dextrose), fructose (levulose), sucrose (sugar), maltose, invert sugar, partially hydrolyzed starch and corn syrup solids, and mixtures thereof. Suitable sugar alcohol bulking agents include sorbitol, xylitol, mannitol, maltitol, and mixtures thereof. Maltitol is disclosed in U.S. Pat. No. 3,708,396 as being a sweet, non-caloric, water-soluble sugar alcohol useful as a bulking agent in the preparation of non-caloric beverages and foodstuffs.

Low-caloric compositions comprising microcrystalline mesoerythritol particles whose surface has been coated with a sweetening component containing at least one non-sugar sweetener are shown in U.S. Pat. No. 5,080,916. Similarly, mesoerythritol preparations are taught in U.S. Pat. No. 4,886,677 whose surface has been modified with water, a non-saccharide sweetening agent, a sugar alcohol or a saccharide.

Thus many bulking agents and sweetener combinations are available for use to prepare products that have acceptable bulk and texture. There is still a need, however, for bulked sweetener compositions that have the look, feel, texture and consistency of sucrose sugar with significantly less calories.

### SUMMARY OF THE INVENTION

Applicants have discovered a sweetener composition comprising an intimate mixture of at least one intense sweetener, particularly chlorodeoxysugar derivatives, such as sucralose, and a non-hygroscopic sweetener that is preferably poorly digested in the human body, such as sugar alcohols, including erythritol, xylitol, isomalt, lactitol, mannitol, maltitol and mono- and di-saccharide compounds such as trehalose, lactose or tagatose in agglomerated granule form. The sweetener composition is in the form of a powder or granular, free-flowing mass.

Another embodiment of the present invention is a granulate and process for preparing a granulate having intense sweetener particles affixed thereto that is particularly suitable for use as a concentrated or bulked sweetening composition.

One embodiment of the present invention is a sweetener composition that contains an intimate mixture of at least one chlorodeoxysugar derivative and a non-hygroscopic sugar alcohol. The sweetener composition can be characterized by having at least some or all of the intimate mixture as an agglomerated granule consisting essentially of non-hygroscopic sugar alcohol particles and sucralose particles.

Another embodiment of the present invention is a sweetener composition that contains an intimate mixture of at least one chlorodeoxysugar derivative and a selected non-hygroscopic sugar. The sweetener composition can be characterized by having at least some or all of the intimate mixture as an agglomerated granule consisting essentially of the selected non-hygroscopic sugar particles and sucralose particles.

The foregoing sweetener compositions can, in one aspect of the invention, be formed by spray drying an aqueous solution containing on a dry basis about 0.1 to 20 percent by weight of at least one chlorodeoxysugar derivative and about 99.9 to 80 percent by weight of a non-hygroscopic carrier agent selected from the group consisting of erythritol, trehalose, lactitol, tagatose and mixtures thereof. Preferably, the sweetener composition contains sucralose. Alternatively, the sweetener is in the form of agglomerated granules consisting essentially of sucralose and erythritol.

Another embodiment of the present invention is a food product containing a sweetener composition as described herein. The food product can be selected from the group consisting of baked goods, baked good mixes, dairy products, frozen dairy products, gum, candies, sauces, glazes, and carbonated and non-carbonated beverages.

Another embodiment of the invention is a process for making a food product by adding a sweetener composition as described herein to the ingredients for a food product.

Another embodiment of the present invention is a medicinal product containing a pharmaceutical active ingredient and a sweetener described herein. The medicinal product can be in tablet form, in liquid form or a liquid suspension.

Another embodiment of the present invention is a process for making a medicinal product by adding a sweetener composition as described herein to the ingredients for a medicinal product.

Another embodiment of the present invention is a process for making a sweetener composition by forming an aqueous mixture of a chlorodeoxysugar derivative and at least one non-hygroscopic carrier agent; and codrying said mixture to form a sweetener composition. The aqueous mixture can contain sucralose and erythritol and be codried by spray drying.

Another embodiment of the present invention is a composition comprising a product obtained by co-spray-drying, in an air stream at a temperature of 40 to 300° C., an aqueous mixture consisting essentially of at least one chlorodeoxysugar derivative and at least one non-hygroscopic carrier agent dissolved in water, and having a chlorodeoxysugar content of 0.05 to 20 percent by weight and a non-hygroscopic sugar alcohol content of 99.95 to 80 percent by weight.

Another embodiment of the present invention is a process for the preparation of a sweetener composition comprising by preparing an aqueous mixture consisting essentially of at least one chlorodeoxysugar derivative and at least one non-hygroscopic carrier agent in an aqueous system, and having a chlorodeoxysugar derivative content of 0.05 to 20 percent by weight and a non-hygroscopic carrier agent content of 99.95 to 80 percent by weight; and co-spray-drying the aqueous mixture in an ascending air stream at a temperature from 40 to 300° C., such that water is evaporated therefrom, and isolating the sweetener composition.

These inventions and other inventions will be apparent to those skilled in the art from reading the following specification (including the Examples and Claims).

### DETAILED DESCRIPTION OF THE INVENTION

Sucralose and the methods of making sucralose and its derivatives have been described in numerous patents such as U.S. Pat. Nos. 4,801,700; 4,950,746; 5,470,969; and 5,498,709 which are hereby incorporated herein by reference.

The intense sweetening agents (sweeteners) in the present invention are chlorodeoxysugar derivatives. The chlorodeoxysugar derivatives may be selected from the group consisting of chlorodeoxysucrose derivatives, chlorodeoxygalactosucrose derivatives, and mixtures thereof. Examples of chlorodeoxysucrose and chlorodeoxygalactosucrose derivatives include but are not limited to:

(a) 1-chloro-1′-deoxysucrose;

(b) 4-chloro-4-deoxy-alpha-D-galactopyranosyl-alpha-D-fructofuranoside, or 4-chloro-4-deoxygalactosucrose;

(c) 4-chloro-4-deoxy-alpha-D-galactopyranosyl-1-chloro-1-deoxy-beta-D-fructofuranoside, or 4,1′-dichloro-4,1′-dideoxygalactosucrose;

(d) 1′,6′-dichloro-1,6′-dideoxysucrose;

(e) 4-chloro-4-deoxy-alpha-D-galactopyranosyl-6-dichloro-1,6-dideoxy-beta-D-fructofuranoside, or 4,1′,6′-trichloro-4,1′,6′-trideoxygalactosucrose;

(f) 4,6-dichloro-4,6-dideoxy-alpha-D-galacto-pyranosyl-6-chloro-6-deoxy-beta-D-fructofuranoside, or 4,6,6′-trichloro-4,6,6′-trideoxygalactosucrose;

(g) 6,1′,6′-trichloro-6,1′, 6′-trideoxysucrose;

(h) 4,6-dichloro-4,6-dideoxy-alpha-D-galacto-pyranosyl-1,6-dichloro-1,6-dideoxy-beta-D-fructo-furanoside, or 4,6,1′,6′-tetrachloro-4,6,1′,6′-tetra-deoxygalactosucrose; and

(i) 4,6,1′,6′-tetrachloro-4,6,1′,6′-tetra-deoxysucrose.

In a preferred embodiment, the chlorodeoxysugar derivative is 4,1′,6′-trichloro-4,1′,6′-trideoxygalacto-sucrose (C₁₂H₁₉Cl₃O₈, 4-chloro-4-deoxy-alpha-D-galacto-pyranosyl-1,6-dichloro-1,6-dideoxy-beta-D-fructo-furanoside) which is commercially available under the tradename Sucralose from Tate and Lyle Sucralose Inc, McIntosh, Ala. Sucralose is a free-flowing white crystalline solid that is freely soluble in water. Sucralose is prepared from sucrose in a multi-step process that selectively substitutes three chlorine atoms for three hydroxyl groups.

The agglomerated unit or granule for the sweetener compositions of the present invention further includes particles of at least one non-hygroscopic carrier agent. A hygroscopic compound or material readily absorbs water, usually from the surrounding atmosphere. The presence of a strongly hygroscopic material in the bulked sweetener composition would be detrimental to long-term shelf stability. A measure of the hygroscopicity of a product is consequently the magnitude of the increase or decrease in its water content as a function of relative humidity at a certain temperature. Non-hygroscopic products exhibit no or only a slight change in their water content as a consequence of variations in relative humidity. For example, a preferred strongly non-hygroscopic carrier agent suitable for the sweetener composition in the invention is trehalose. Trehalose has no moisture up take at a continuous 94% relative humidity condition. In contrast, inulin and fructo-oligosaccharide and sorbitol are hygroscopic materials. Inulin absorbs moisture and dissolves into a liquid at a relative humidity of about 45% or higher.

The preferred non-hygroscopic carrier agents of the present invention will have only a slight increase in its water content (less than 10% absorption) at a relative humidity of at least 80%, preferably at least about 85% humidity, most preferably at least about 90% relative humidity.

An additional preferred feature of the non-hygroscopic carrier agent is poor digestibility. A poorly digestible product is only partially metabolized in the human body so that most of the product passes through the body unabsorbed.

Examples of suitable non-hygroscopic carrier agents for the sweetener compositions of the present invention include a non-hygroscopic sweetener that is poorly absorbed in the human body, such as sugar alcohols, including erythritol, xylitol, isomalt, lactitol, mannitol, maltitol and mono- and di-saccharide compounds such as trehalose, lactose, tagatose and trehalose. All of these materials are commercially available. Materials that are considered weakly non-hygroscopic or even hygroscopic can be included provided that shelf-stability is not materially compromised.

It appears necessary in the process of making a bulked sweetening composition comprising/consisting essentially of a blend of the selected intense sweetener(s) and a non-hygroscopic carrier agent to form an intimate blend of the ingredients rather than just a dry blend. Dry blending of the ingredients does not provide a suitable bulked sweetening composition. The disadvantages of simple dry blending include non-uniformity of blend, active settling or separation plus dusting which often cause product loss during the blending process. The blend of intense sweetener and selected carrier agent can be prepared by a granulating process, such as wet or dry granulation or spray drying an aqueous solution containing the two components in the desired proportions to produce a product having the texture and consistency of sucrose.

The resulting sweetener composition is preferably non-nutritive. The compositions embodied in this invention are free of added nutritive sweeteners. Frequently food ingredients, such as, flavors that may be used in this invention, contain some levels of nutritive sweeteners to serve as fillers or stabilizing agents. Therefore, the compositions of this invention may contain small amounts of nutritive sweeteners introduced from other ingredients. It is contemplated that generally any nutritive sweetener introduced from other food ingredients will be less than about 5 to about 10 weight percent of the final composition. Such nutritive sweeteners include, but are not limited to, sucrose, glucose, high fructose corn syrup, or fructose.

The sweetener composition preferably has on a weight-to-weight basis a sweetness equivalent number of at least 0.6, alternatively 0.8, or 1. Further, the sweetener composition preferably has on a weight to weight basis a sweetness equivalent number of no more than 2, alternatively 1.5, or 1.2. Further, the sweetener composition is preferably in the form of a free-flowing powdery or granular mass. The term “powder” means a free flowing solid material having a mean particle size of 1 micron to ⅛ inch, comprised of amorphous or crystalline material, which may have been ground, screened, compressed, milled, agglomerated, coated, panned, or otherwise size or surface modified.

Aqueous solutions containing the selected intense sweetener(s) and selected sugar alcohol can be prepared by dissolving the components in water, either separately or after dry mixing. The relative proportions of the components range from about 0.05 to 20 percent by weight, alternatively 0.1 to 20 % percent by weight of intense sweetener and about 99.9 to 80 percent by weight selected sugar alcohol, each on a dry weight basis. Intense sweetener in amounts greater than about 2% can produce a concentrated sweetener composition. The concentrated sweetener can be used directly as a concentrate or diluted in conventional fashion. A concentrated sweetener composition will have a relative sweetness at least twice as great as sucrose, more typically at least 5 times greater.

Preferably the relative proportion of the components for making a bulked sweetener without having to incorporate filler materials will range from about 0.2 to 2 percent by weight intense sweetener and about 99.8 to 98 percent by weight sugar alcohol. Most preferably the relative proportion of the components will be about 0.3-1 percent by weight of intense sweetener and the remainder selected sugar alcohol(s). The total solids concentration in the solution can be up to about 80%, and preferably from 40 to about 60 percent (by weight), prior to spray- or freeze-drying. Drying can be performed using any standard processing technique.

The first step in preparing the sucralose-containing ingredient of the present invention is to codry the sucralose with at least one selected sugar alcohol. Codrying is a general term for a process in which an active ingredient and a carrier, such as a sugar alcohol, are dissolved or suspended in a liquid carrier that is then evaporated to produce an intimately mixed, dry combination ingredient. Specific processes for carrying out codrying operations include the well-known processes of spray drying, freeze drying and moist granulation. The moist granulation process has been disclosed in U.S. Pat. No. 4,863,745, which is incorporated herein by reference. Any codrying method can be used, with spray drying and moist granulation being preferred. Spray drying is suitable for producing a final product having a broad range of bulk density of about 0.1 g/ml to 0.6 g/ml, while granulation is most suitable for products having a bulk density of at least 0.3 g/ml.

Spray drying and associated equipment is well known in the art. One method for preparing the compositions described herein requires preparing an aqueous solution consisting essentially of the selected intense sweetener or mixture of intense sweeteners and at least one non-hygroscopic carrier agent dissolved in water, and having 0.05 to 20 percent by weight of an intense sweetener(s) and a non-hygroscopic content of 99.95 to 80 percent by weight, each on a dry weight basis, co-spray-drying the solution into an ascending air stream at a temperature from 40 to 300° C., such that water is evaporated therefrom, and isolating the product composition. The aqueous solutions can be prepared using either separate or blended dry mixtures of the selected intense sweetener(s) and at least one selected non-hygroscopic carrier agent. Spray drying can be utilized to produce a final product having a bulk density ranging from 0.1 to 0.8 g/ml.

The resulting product preferably includes at least some agglomerated granules consisting essentially of the selected intense sweetener and selected non-hygroscopic carrier agent(s). More preferably, the resulting product is an agglomerated unit or granule consisting essentially of a chlorodeoxysugar, such as sucralose, and a non-hygroscopic carrier agent, such a sugar alcohol. A granule is one particle of a collection of several particles or an agglomeration forming a larger unit.

Bulked sweeteners can be used in a variety of medicinal products, food products such as cooked and hard candies (e.g. caramels, cough drops, etc.), microwave food products, glazed food products (e.g. honey baked hams), deep fried food products (e.g. doughnuts), and as an ingredient in prepared food product mixes as a direct substitute for sucrose.

For example a flavored sugar free or reduced sugar hard candy can be made by combining isomalt (200 gm) and water (70 gm) in a pan and heating the mixture to 170° C. Optionally, sugar could be added to this mixture, but is not necessary. After the mixture has reached 170° C. and has the appropriate water content, the mixture is cooled to about 135-130° C. and flavorings and the bulked sweetener is added. To make a fruit flavored sugar free hard candy, citric acid (3 gm), colorant (as desired), flavor (about 0.4 gm) and bulked sweetener (200(to make˜60% sugar sweetness)gm) would be added. The candy could then be shaped or molded and cooled until solid. The hard candy formed by this process will have lower calorie content than a corresponding candy made from sucrose and appropriate levels of sweetness.

The following non-limiting examples are provided to further illustrate the present invention. Numerous other embodiments of the present invention are possible which are consistent with the invention disclosed herein.

### EXAMPLES

The following examples demonstrate the inventive compositions and means for the preparation of non-hygroscopic, no-calorie sugar substitute compositions.

### Example 1

3 kg of erythritol powder is weighed and placed in a Glatt spray-granulator. A previously prepared sucralose/erythritol solution containing 20 grams of sucralose and 10 grams of erythritol in 360 mL of hot water at 50° C. is sprayed onto the erythritol powder at 35-60° C. Approximately 200 grams of the solution is sprayed and granulated with the erythritol powder. The density of the resulting spray-dried powder can be controlled by adjusting the dryer spray rate, granulation rate, and hot air temperature. The spraying/granulation process takes about 15 to 30 minutes to complete. Once granulation is complete and the desired density is obtained, the mixture is further dried for 5 minutes.

### Example 2

1.8 kg of erythritol powder, 0.6 kg of trehalose, 0.6 kg of tagatose powder, and 12 grams of sucralose are dissolved in 3 kg of hot water at 50 to 60° C. The solution is spray dried in similar fashion described in example 1 to a bulk density of 0.3 g/mL for use as a stable non-hygroscopic, no-calorie sugar substitute.

### Example 3

1.2 kg of erythritol, 1.2 kg of trehalose, 0.6 kg of tagatose, and 12 grams sucralose are dissolved in 3 kg of hot water at 50 to 60° C. The solution is spray dried in similar fashion described in example I to a bulk density of 0.2 g/mL for use as a stable non-hygroscopic, no-calorie sugar substitute.

Composition and ingredients for examples 1-3.

| Ingredients | Example | | |
|---|---|---|---|
| (Wt. %) | 1 | 2 | 3 |
| Sucralose | 0.3 | 0.4 | 0.6 |
| Erythritol | 99.4 | 60 | 40 |
| Trehalose | 0 | 20 | 40 |
| Tagatose | 0 | 20 | 20 |
| Density | 0.4 | 0.3 | 0.2 |
| | g/mL | g/mL | g/mL |

What is claimed is:

1. A sweetener composition comprising an intimate mixture of at least one chlorodeoxysugar derivative and at least one non-hygroscopic sweetener carrier having sweetness less than sucrose, wherein the composition is in the form of a powder or granular, free-flowing mass.

2. The sweetener composition of claim 1 containing an intimate mixture comprising from about 0.05 to 20 percent by weight percent by weight of at least one chlorodeoxysugar derivative and from about 99.95 to 80 percent by weight at least one non-hygroscopic sweetener carrier selected from the group consisting of erythritol, xylitol, isomalt, lactitol, mannitol, maltitol, trehalose, lactose, tagatose and mixtures thereof.

3. The sweetener composition of claim 1 wherein at least some of the intimate mixture is an agglomerated granule consisting essentially of non-hygroscopic sugar alcohol particles and sucralose particles.

4. The sweetener composition of claim 1 wherein the bulked sweetener is formed by spray drying an aqueous solution containing on a dry basis about 0.1 to 40 percent by weight of at least one chlorodeoxysugar derivative and about 99.9 to 60 percent by weight of a sugar alcohol selected from the group consisting of erythritol, trehalose, lactitol, tagatose and mixtures thereof.

5. The sweetener composition of claim 1 that comprises sucralose.

6. The sweetener composition of claim 4 wherein at least some of the sweetener composition is in the form of agglomerated granules consisting essentially of sucralose and erythritol.

7. A bulked sweetener composition that consists essentially of agglomerated granules of sucralose and erythritol.

8. A bulked sweetener composition containing an intimate mixture comprising from about 0.05 to 2 percent by weight percent by weight of at least one chlorodeoxysugar derivative and from about 99.95 to 98 percent by weight of at least one non-hygroscopic sweetener carrier selected from the group consisting of erythritol, xylitol, isomalt, lactitol, mannitol, maltitol, trehalose, lactose, tagatose and mixtures thereof.

9. A bulked sweetener according to claim 10 wherein at least some of the sweetener composition is in the form of agglomerated granules consisting essentially of sucralose and erythritol.

10. A food product containing a sweetener composition according to claim 1.

11. An agglomerated granule comprising particles of at least one chlorodeoxysugar derivative and at least one non-hygroscopic sugar alcohol.

12. The sweetener composition according to claim 1 having on a weight to weight basis a sweetness equivalent number of at least 0.6,

13. The sweetener composition according to claim 1 having on a weight to weight basis a sweetness equivalent number of about 1.

14. The sweetener composition according to claim 12 having on a weight to weight basis a sweetness equivalent number of no more than 2

15. The sweetener composition according to claim 1 wherein non-hygroscopic sweetener carrier is poorly digestible and the sweetener composition as a whole is non-nutritive.

16. A process for making a bulked sweetener composition comprising (a) forming an aqueous mixture of a chlorodeoxysugar derivative and at least one non-hygroscopic sweetener carrier; and (b) codrying said mixture to form a bulked sweetener.

17. The process of claim 16 wherein the aqueous mixture contains sucralose and erythritol and is codried by spray drying.

18. A composition comprising a product obtained by co-spray-drying, in an air stream at a temperature of 40 to 300° C., an aqueous mixture consisting essentially of at least one chlorodeoxysugar derivative and at least one non-hygroscopic sweetener carrier having a sweetness less than sucrose dissolved in water, and having a chlorodeoxysugar content of 0.05 to 20 percent by weight and a non-hygroscopic sweetener carrier content of 99.95 to 80 percent by weight.

19. The composition of claim 18, wherein the product has a bulk density of about 0.1 to 0.8 g/ml.

20. A process for the preparation of a sweetener composition comprising:
a) preparing an aqueous mixture consisting essentially of at least one chlorodeoxysugar derivative and at least one non-hygroscopic carrier agent having a sweetness less than sucrose in an aqueous system, and having a chlorodeoxysugar derivative content of 0.05 to 40 percent by weight and a non-hygroscopic carrier agent content of 99.95 to 60 percent by weight;
b) co-spray-drying the aqueous mixture into an ascending air stream at a temperature from 40 to 300° C., such that water is evaporated therefrom, and
c) isolating the bulked sweetener composition in a powder or granular form.

21. The composition of claim 20, wherein the product has a bulk density of about 0.3 to 0.6 g/ml.
